(19) United States
(12) Patent Application Publication
(10) Pub. No.: US 2024/0309780 A1
(43) Pub. Date: Sep. 19, 2024

(54) TURBOMACHINE WITH COOLING SYSTEM USING LUBRICATION OIL

(71) Applicant: PUNCH TORINO S.P.A., Torino (IT)

(72) Inventors: Luca Buzzi, Torino (IT); Luigi Di Gennaro, Torino (IT); Carmine Russo, Torino (IT)

(73) Assignee: PUNCH TORINO S.P.A., Torino (IT)

(21) Appl. No.: 18/578,290

(22) PCT Filed: Jul. 27, 2022
(86) PCT No.: PCT/IB2022/056942

§ 371 Date: Jan. 10, 2024

(30) Foreign Application Priority Data
Jul. 29, 2021 (IT) 102021000020378

(51) Int. Cl. F01D 25/18; F01D 25/12

(52) U.S. Cl. CPC F01D 25/183; F01D 25/125; F05D 2240/128

(57) ABSTRACT

A turbomachine (10) comprising: •—a turbine provided with an turbine wheel •—sealing means, designed to prevent lubrication oil from escaping towards the turbine wheel, •—a cooling system exclusively based on heat removal by the lubricating oil, which includes a main channel for feeding the lubricating oil to support means of the turbomachine, wherein •—the cooling system is provided with at least one spray-channel for cooling the sealing means, fluid-dynamically connected to the main channel and able to supply a flow of lubricating oil fed directly or indirectly, from the main channel; —the spray-channel is provided, in a distal position with respect to the main channel, with a spray nozzle (5a) facing the sealing means.

### BACKGROUND OF THE INVENTION

### 1. Field of the Invention

Field of the invention The present invention relates to a turbomachine equipped with an innovative cooling system. More specifically, the cooling system is based on oil jets and is particularly suitable for turbochargers of internal combustion engines.

### 2. Brief Description of the Prior Art

Background art, as is known, turbomachines are machines in which the exchange of energy with the fluid takes place thanks to the rotation of a wheel, also known as a rotor or impeller, splined to a shaft, equipped at the periphery with blades, and housed in a case (known as a stator) which may also be equipped with blades. In the context of turbomachinery, the turbocharger (or turbo-unit or, more simply, turbo) has as its main purpose the supercharging of the internal combustion engine. The turbocharger is defined by the coupling of a centripetal turbine and a centrifugal compressor. The turbine constitutes the ‘hot’ or exhaust side of the turbo-compressor, where the high temperature exhaust gases are received, while the centrifugal compressor is the ‘cold’ or intake side, where the air to be compressed is drawn in. It constitutes the most common method of turbocharging endothermic engines, particularly those for motor vehicles.

The temperatures reached on the hot side of the turbocharger, related to the high enthalpy of the exhaust gases, are of the order of several hundred degrees Celsius and require reliable cooling systems that remove heat from the components subjected to these high temperatures, especially the sealing media on the turbine side.

The cooling of the most critical areas of a turbocharger's core body is done indirectly by circulating only the lubrication oil intended to support the bearing load, which at the same time also removes the necessary heat. Cooling can also occur through a combination of oil circulation and water circulation, the latter in a dedicated circuit. The adoption of the water circuit usually applies to compression-ignition and spark-ignition engines where combustion conditions involve exhaust gas temperatures so high that the structural strength of the mechanical components is compromised.

The adoption of a water-cooling circuit is necessary not only during the operating conditions of the internal combustion engine, but also immediately after it has been switched off. In fact, once the endothermic engine is switched off, the turbine transmits a heat wave to the entire turbocharger casing inside which, in the meantime, no more oil circulates.

This creates excessive overheating of the bearings and especially the turbine seals. The use of the water-cooling circuit is effective because water has the advantage over oil that, due to the thermosiphon effect, it continues to circulate even after the internal combustion engine is switched off and thus continues its heat-removal function.

On the other hand, the addition of water circulation entails a considerable complication in the design of the turbocharger, in particular in the design of the central body, and an increase in costs for tooling and layout of the water channels. In addition, the piping required to bring water to the turbocharger also represents a non-negligible cost.

There is therefore a need to solve the technical problem mentioned above by means of an innovative solution that avoids the use of a specific water cooling circuit to cool the turbocharger even in the highest performance engine applications.

### SUMMARY OF THE INVENTION

The aim of the present invention is to realize a turbo-machine equipped with a cooling system which does not require the adoption of a water-cooling circuit. More specifically, the cooling system according to the present invention is dedicated to the most critical areas of the central body of a turbocharger-bearing unit and sealing means—and is based on a suitable oil sprayer with well-defined and optimized dimensioning and positioning.

Accordingly, according to an aspect of the present invention a turbo-machine is provided having a cooling system having the characteristics set forth in the independent product claim appended hereto.

Further preferred and/or particularly advantageous embodiments of the invention are described according to the features set forth in the attached dependent claims.

### BRIEF DESCRIPTION OF THE DRAWINGS

The invention will now be described with reference to the appended drawings, which illustrate a non-limiting example embodiment, wherein:

FIG. 1 schematically illustrates the cooling system of a turbomachinery according to a first embodiment of the present invention,

FIG. 2 schematically illustrates the cooling system in a second embodiment of the present invention,

FIG. 3 schematically illustrates the cooling system in a third embodiment of the present invention, and

FIG. 4 is a detail, in enlargement and with parts removed for clarity, of the forms of implementation referred to in FIGS. 1 to 3.

### DETAILED DESCRIPTION OF THE PREFERRED EMBODIMENTS

As already mentioned, the present invention is a turbo-machine and, in particular, a turbocharger for turbocharging high-performance endothermic engines, in which the cooling of the turbocharger is, according to known technique, also entrusted to a water circuit in addition to the lubrication oil. However, the present invention is any type of turbo-machine in which the use of a water cooling circuit is to be avoided.

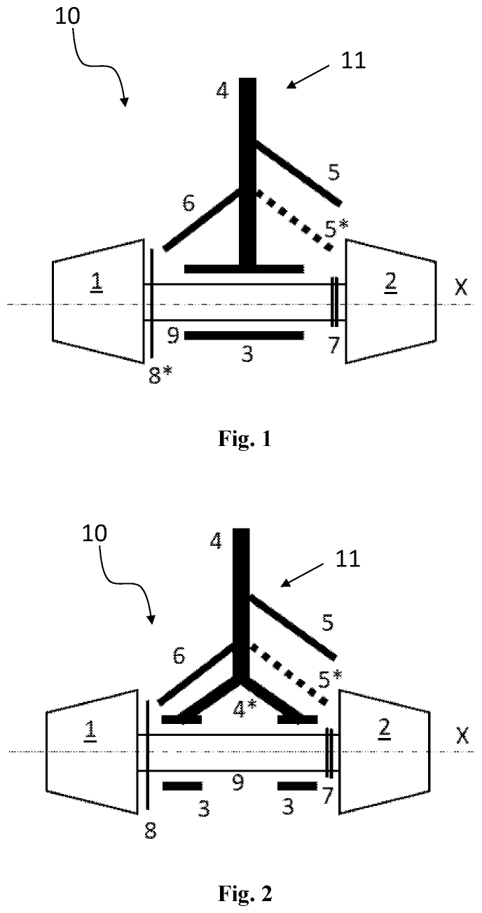

With reference to FIG. 1, denotes a turbomachine 10 for endothermic engines of a known type, schematically shown in its essential components. In particular, the turbomachine 10 may have an axisymmetric geometry about an axis of rotation X and may comprise:
a compressor 1 provided with a relative impeller, for compressing the air supply of the endothermic engine (or other suitable fluid), when the air to be compressed has been sucked in,—a turbine 2 equipped with its impeller, for the expansion of the exhaust gases of the endothermic engine,
a rotatable shaft 9 connecting the turbine and the compressor,
support means 3, 3*, 8, 8* of shaft 9. A semi-floating plain bearing 3 in which the floating ring does not rotate and a thrust ring 8* is schematically shown in FIG. 1,—sealing means 7, on the turbine 2 side to seal the lubrication oil to the turbine 2 impeller and prevent the hot gases of the endothermic engine from escaping from the “hot” side of the turbocharger, i.e. the turbine 2 impeller,—a cooling 11 and lubrication system of the turbomachine 10.

According to the invention, the cooling 11 and lubrication system is realized within the central body of the turbocharger (of a known type and for this reason not shown in the diagrams of FIGS. 1-4) and comprises:
a main oil supply channel 4 (also used for lubrication of the turbocharger, as well as for its cooling). The main channel 4, as schematized in FIG. 1, can deliver a flow of oil to the semi-floating plain bearing 3 directly or by means of further channels not shown for simplicity,
a branch 6 which takes some of the oil flow from the main channel 4 and adds it to the thrust ring 8*. In this configuration, the thrust ring 8* could also be integrated into the semi-floating plain bearing 3,
at least one spray-channel 5, 5* for cooling the sealing media 7.

The spray-channel 5, 5*, the position or number of which may vary depending on the application and is illustrated in FIG. 1 in two exemplary positions, draws a flow of oil, directly or indirectly, from the main channel 4, to which it is connected, and terminates with a spray nozzle 5a whose diameter f5 and distance d from the sealing means 7 are predetermined as will be better described below. The spray nozzle 5a is therefore in the distal position of spray-channel 5, 5* respect to the main channel 4.

With reference to FIG. 2, the turbomachine 10 differs in that the support means comprise a pair of floating plain bearings 3 (in which, that is, the corresponding floating rings rotate) and a thrust ring 8.

According to the invention, the cooling 11 and lubrication system implemented within the turbomachine 10 body comprises:
a main oil supply channel 4 (also serving to lubricate the turbocharger, as well as to cool it). The main channel 4 delivers a flow of oil to the floating plain bearings 3 by means of further channels 4*,
a branch 6 which takes a part of the oil flow of the main channel 4 and feeds it to the thrust ring 8,
at least one spray-channel 5, 5* for cooling the sealing means 7. The spray-channel 5, 5*, the position or number of which may vary depending on the application and in FIG. 2 is illustrated as an example in two positions, draws a flow of oil, directly or indirectly, from the main channel 4, to which it is connected, and terminates with a spray nozzle 5a whose diameter f5 and distance d from the sealing means 7 are predetermined. Also in this example of implementation, the spray nozzle is located at the distal position of the spray-channel 5, 5* respect to the main channel 4.

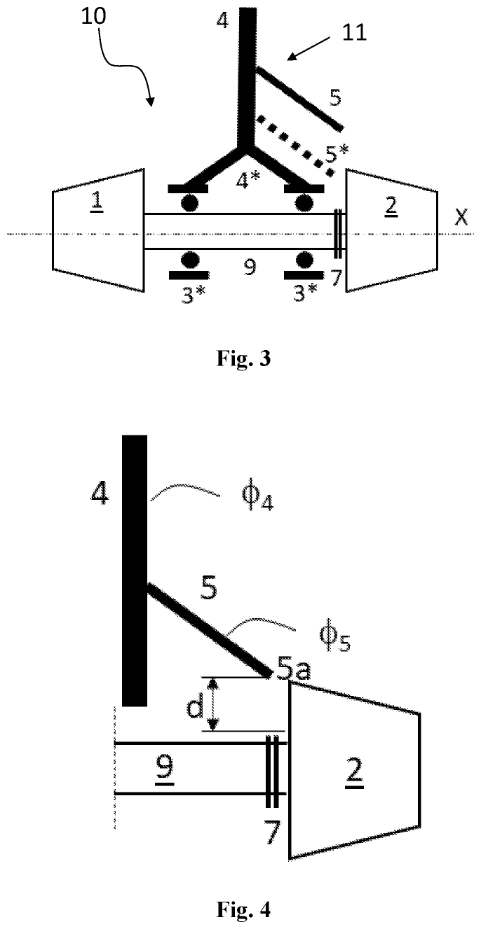

With reference to FIG. 3, turbomachine 10 differs in that the bearings comprise a pair of rolling bearings 3* capable of supporting radial and axial loads. For this reason, the turbocharger in this configuration does not require thrust rings. Of course, if rolling bearings capable of withstanding only radial loads were to be used, a thrust ring would also have to be provided, but this form of implementation will also be covered by the present invention. According to the invention, the turbomachine cooling 11 and lubrication system 10 implemented within the turbocharger body comprises:
a main oil supply channel 4 (also serving the lubrication of the turbocharger, as well as its cooling). The main channel 4 delivers a flow of oil to the rolling bearings 3* by means of further channels 4*,
at least one spray-channel 5, 5* for cooling the sealing means 7.

The spray-channel 5, 5*, the position or number of which may vary depending on the application and in FIG. 3 is illustrated as an example in two positions, draws a flow of oil, directly or indirectly, from the main channel 4, to which it is connected, and terminates with a spray nozzle 5a whose diameter f5 and distance d from the sealing means 7 are predetermined. Also, in this example of implementation, the spray nozzle is located at the distal position of the spray-channel 5, 5* respect to the main channel 4. According to the present invention, the spray-channel 5, 5* is realized in the turbomachine central body 10. The spray-channel is suitably oriented so as to direct the oil jet towards the oil sealing means 7 from the turbine side 2, without, however, directly hitting them, and is fed by a flow spill from the main oil supply channel 4 of the turbocharger or from the further oil channels 4* for the bearings 3, 3*. Preferably, the spray-channel 5-5* can work with oil pressures within 10 bar.

It is evident that the embodiments of the invention, described above, represent non-limiting examples: in particular, the type, arrangement and load carrying capacities of the bearings presented are not intended to limit the invention to the examples described, any architecture of turbocharger shaft support elements may be adopted within the same inventive concept.

With reference to FIG. 4, it should be noted that it is important for the purposes of the present invention to dimension the spray-channel 5, 5* both with regard to its diameter f5 which will determine the flow rate of oil tapped from the main channel 4, and with regard to the distance from the sealing means 7, which will determine the effectiveness of heat removal by the flow rate of oil tapped from the spray-channel.

Regarding the diameter f5 of spray-channel 5, 5*, it must be related to diameter f4 of the main channel 4. Advantageously, the effectiveness of the solution is achieved if diameter f5 of spray-channel 5, 5* is between 10% and 25% of diameter f4 of the main channel 4. Since the diameter f4 of main channel 4, in high-performance endothermic engine applications, takes values between 5 mm and 6 mm, an optimal range for diameter sizing f5 of the spray-channel 5, 5* will be between 0.7 mm and 1.3 mm. Percentage values of F5/F4 lower than 10% would make the realisation of the spray-channel 5, 5* technologically complex or even unfeasible, while percentage values of F5/F4 greater than 25% would create excessive oil bleed in the spray-channel which would be to the detriment of the lubrication of the turbocharger shaft bearings.

The distance d of the end portion of the spray-channel 5, 5*, i.e., of the spray nozzle 5a, from the sealing means 7 is another important parameter for the correct dimensioning of the cooling system 11: with a very small distance there is a risk that the oil will directly and at high speed invade the sealing means 7, impairing their very functionality. On the contrary, oil must never be directed onto the sealing rings while being sprayed in an area facing them. Preferably, it would be useful to protect the area of the sealing means from any direct contact with the lubrication oil by means of a suitable deflector, which can be made from the same casting as the turbine body. Conversely, an excessive distance would make the heat removal function of the sealing media 7 ineffective. It is therefore advisable, depending on the application, to relate the distance d to the diameter f5qi the spray-channel 5, 5*. A suitable range, confirmed by calculation and experimental tests, is as follows: 5 f5<d<12 f5 i.e. with the distance d between spray nozzle 5a and turbine-side sealing medium 7 between five and twelve times the diameter f5 of the spray channel 5, 5*.

The adoption of the channel-sprayer makes it possible to achieve cooling of the most critical areas (oil seal media on the turbine side) comparable to the indirect cooling obtainable with water circulation.

In other words, this solution allows the use of a water-cooling circuit to be avoided where possible, by retaining the entire cooling of the turbomachine to the lubrication oil alone. This is certainly advantageous from an economic point of view, but not only:
many of today's engine architectures require the turbo to be located in the upper portion of the engine compartment. This does away with the thermosiphon effect mentioned in the introduction and also eliminates the residual advantage of using water cooling;—oil cooling, according to the present invention, allows the heat wave (which occurs when the engine is switched off) to start from lower temperatures, so that the temperature limits are not exceeded. Thus, with this type of cooling, the same principle is used as with water cooling, making the latter no longer necessary. In addition to the form of the invention as described above, it must be understood that there are numerous other variants. It must also be understood that these forms of embodiment are merely illustrative and do not limit either the scope of the invention, its applications or its possible configurations. On the contrary, although the above description allows the skilled person to implement the present invention at least according to one exemplary form of embodiment thereof, it should be understood that many variations of the described components are possible, without thereby departing from the scope of the invention as defined in the appended claims, which are interpreted literally and/or according to their legal equivalents.

1. A turbomachine (10) comprising: at least one turbine (2) provided with an impeller sealing means (7), designed to prevent lubrication oil from escaping towards the turbine wheel (2), a cooling system (11) exclusively based on heat removal by the lubricating oil which includes a main channel (4) for feeding the lubricating oil to support means (3, 3*, 8, 8*) of the turbomachine (10), the turbomachine (10) being characterized by the fact that—the cooling system (11) comprises at least one spray-channel (5, 5*) for cooling the sealing means (7), fluid-dynamically connected to the main channel (4) and able to supply a flow of lubricating oil fed directly or indirectly, from the main channel (4); the spray-channel (5, 5*) is provided, in a distal position with respect to the main channel (4), with a spray nozzle (5a) facing the sealing means (7).

2. The turbomachine (10) according to claim 1, wherein a diameter (f5) of the spray-channel (5, 5*) is between 10% and 25% of a diameter (f4) of the main channel (4).

3. The turbomachine (10) according to claim 2, wherein for values of the diameter (f4) of the main channel (4) between 5 mm and 6 mm, corresponding values of the diameter (f5) of the spray-channel (5, 5*) are between 0.7 mm and 1.3 mm.

4. The turbomachine (10) according to claim 1, wherein said spray nozzle (5a) has a distance (d) from the sealing means (7) between five and twelve times the diameter (f5) of the spray-channel (5, 5*).

5. The turbomachine (10) according to claim 1, wherein the turbine (2) comprises a body provided with a deflector designed to protect sealing means (7) from direct contact with the lubricating oil.

6. The turbomachine (10) according to claim 1, further comprising a branch (6) fluid-dynamically connected to the main channel (4), containing a lubricating oil flow coming from the main channel (4) and fed to a thrust ring (8, 8*) of the turbomachine (10).

7. The turbomachine (10) according to claim 6, in which the main channel (4) is provided with further channels (4*) for supplying lubricating oil to floating plain bearings (3) of the turbomachine (10).

8. The turbomachine (10) according claim 4, in which the main channel (4) is provided with further channels (4*) for supplying lubricating oil to rolling bearings (3*) of the turbomachine (10).

9. The turbomachine (10) according to claim 1, in which inside the spray-channel (5, 5*), the lubricating oil pressure assumes values not exceeding 10 bar.

10. The turbomachine (10) according to claim 1, further comprising: a compressor (1), a shaft (9), rotatable, connecting the turbine (2) and the compressor (D, support means (3, 3*, 8, 8*) of the shaft (9).
